(19) United States
(12) Patent Application Publication
(10) Pub. No.: US 2006/0045755 A1
(43) Pub. Date: Mar. 2, 2006

(54) Information handling system including AC electromagnetic pump cooling apparatus

(75) Inventors: Brent A. McDonald, Round Rock, TX (US); Daniel E. Jenkins, Bastrop, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/925,240

(22) Filed: Aug. 24, 2004

(51) Int. Cl. F04B 37/02; F04F 11/00; H02K 44/00

(52) U.S. Cl. 417/50; 417/48

(57) ABSTRACT

An information handling system (IHS) is provided which is cooled via an electromagnetic pump. The pump pushes a heat conducting liquid metal fluid in a heat conducting path away from a heat producing device such as a processor. The EM pump is driven by an AC electric current supplied to a transformer. The AC driven transformer supplies both a magnetic field and an electric current to the fluid in the pump. The system is configured such that the magnetic field and the electric current in the fluid are substantially orthogonal. Each time the AC electric current reverses polarity, the magnetic field and the electric current also each change polarity to force fluid out of the pump in the same direction during both the positive and negative going portions of the AC electric current cycle.

### BACKGROUND

The disclosures herein relate generally to information handling systems (IHS's) and more particularly to cooling systems for IHS's.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The rapid increase in the performance of IHS's over the years has been accompanied by an undesirable increase in power consumption by the IHS's processor. This power is dissipated as heat which must be radiated to the environment to prevent overheating the processor. In early processors, simple passive heat sinks mounted on the processor adequately radiated the heat from the processor. However, with the rise in processor power consumption, more sophisticated heat dissipation solutions are required. Fans have been mounted on processor heat sinks to help radiate heat. More recently, IHS's have been designed wherein a liquid filled heat pipe is thermally coupled to a processor to pull heat away from the processor and direct the heat to another location in the IHS where it is radiated to the environment.

Electromagnetic pumps using the Lorentz effect have been used to pull heat away from heat generating devices. In a representative electromagnetic pump (EM pump, also called a Lorentz pump), the pump contains a liquid metal which is to be expelled from the pump. The pump is configured with electrodes to which a DC voltage is applied so that an electric current flows through the liquid metal in the pump. The pump is also configured with permanent magnets positioned to create a magnetic field which is orthogonal to the electric current flowing through the liquid. According to the Lorentz effect, a force is generated which pushes the liquid metal in a direction which is orthogonal to both the electric current and the magnetic field. In this manner, the liquid metal is expelled from the pump in the direction of the force.

The electromagnetic pump described above operates on direct current (DC). To step a supply DC voltage down to a range usable with an electromagnetic pump, a DC to DC converter can be used as shown in FIG. 1. The DC to DC converter includes a bridge which converts a DC voltage to an AC voltage that is stepped down by a transformer to a desired AC voltage level. The bridge includes switching transistors that are turned on and off by a controller to generate an AC voltage in the primary of the transformer. The resultant AC voltage signal generated in the secondary of the transformer is then rectified by secondary rectifiers as shown to obtain a desired low voltage, high current DC signal usable to drive the pump. While the low DC voltage necessary to drive the pump can be achieved this way, the secondary rectifiers dissipate such a large amount of heat energy that this approach is very inefficient.

What is needed is a way to supply electric current to an electromagnetic pump which addresses the above discussed deficiencies in DC powered electromagnetic pumps.

### SUMMARY

Accordingly, in one embodiment, an information handling system (IHS) is disclosed including an AC power input which is operable to be driven by an AC signal. The IHS includes a vessel having a fluid input and a fluid output and having an electrically conductive fluid contained therein. The IHS also includes a transformer coupled to the AC power input. The transformer is configured to provide the fluid in the vessel with an electric current that is substantially orthogonal to a magnetic field such that a force is generated which pushes the fluid through the fluid output in the same direction during both positive and negative polarities of the AC signal.

In another embodiment, a method is disclosed for operating an information handling system (IHS). The method includes providing an electrically conductive fluid to an electromagnetic (EM) pump having a fluid input and a fluid output. The method also includes supplying an AC electric current to a transformer to generate a magnetic field in which the EM pump is positioned. The method further includes supplying AC electric current to the fluid within the EM pump, the EM pump being configured such that the AC electric current in the fluid within the EM pump is substantially orthogonal to the magnetic field in the fluid within the EM pump, thus imparting a force on the fluid to push the fluid through the fluid output during both positive and negative polarities of the AC electric current supplied to the EM pump.

### BRIEF DESCRIPTION OF THE DRAWINGS

FIG. 1 is a block diagram of a conventional DC driven electromagnetic pumps which employs permanent magnets.

FIG. 2 is a block diagram of an information handling system in which the disclosed technology can be employed.

FIG. 3 is a representation a system wherein the disclosed cooling apparatus is employed to remove heat from a heat producing device of an information handling system.

FIG. 4 shows a cross section of the transformer and electromagnetic pump employed is the cooling apparatus of FIG. 3.

FIG. 5A is a timing diagram showing one control signal employed by a DC to AC converter of FIG. 4

FIG. 5B is a timing diagram showing another control signal employed by the DC to AC converter of FIG. 4.

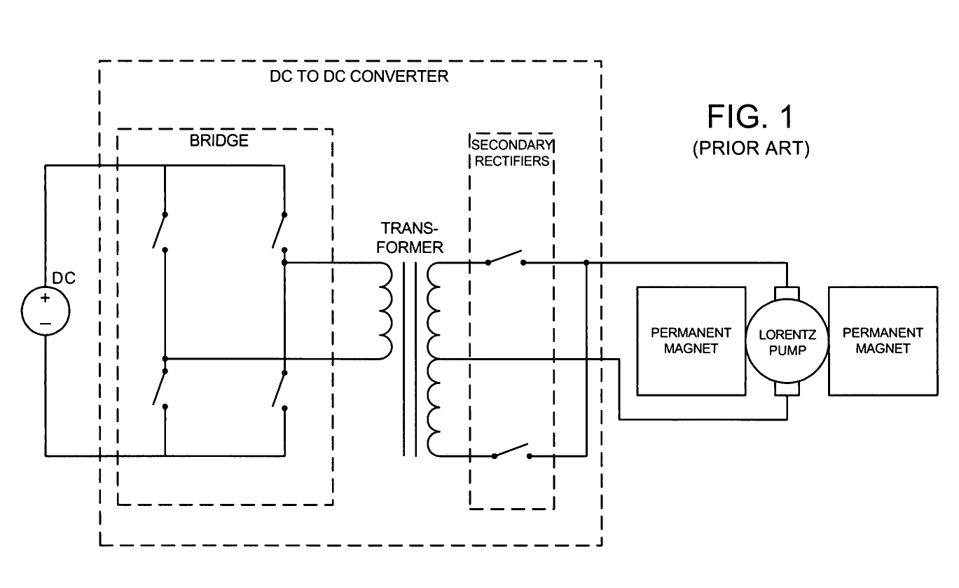

### DETAILED DESCRIPTION

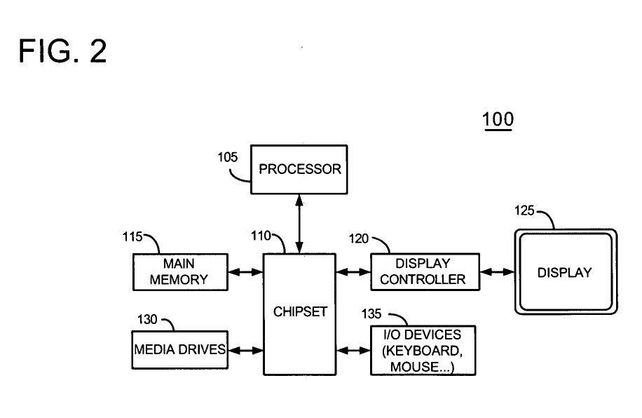

FIG. 2 is a block diagram an information handling system (IHS) 100 in which the disclosed cooling technology can be employed. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

IHS 100 includes a processor 105 such as an Intel Pentium series processor, an Advanced Micro Devices (AMD) processor or one of many other processors currently available. A chipset 110 provides IHS 100 with glue-logic that connects processor 105 to other components of IHS 100. For example, chipset 110 couples processor 105 to main memory 115 and to a display controller 120. A display 125 can be coupled to display controller 120 as shown. Chipset 110 also acts as an I/O controller hub which connects processor 105 to media drives 130 and I/O devices 135 such as a keyboard, mouse, and audio circuitry, for example.

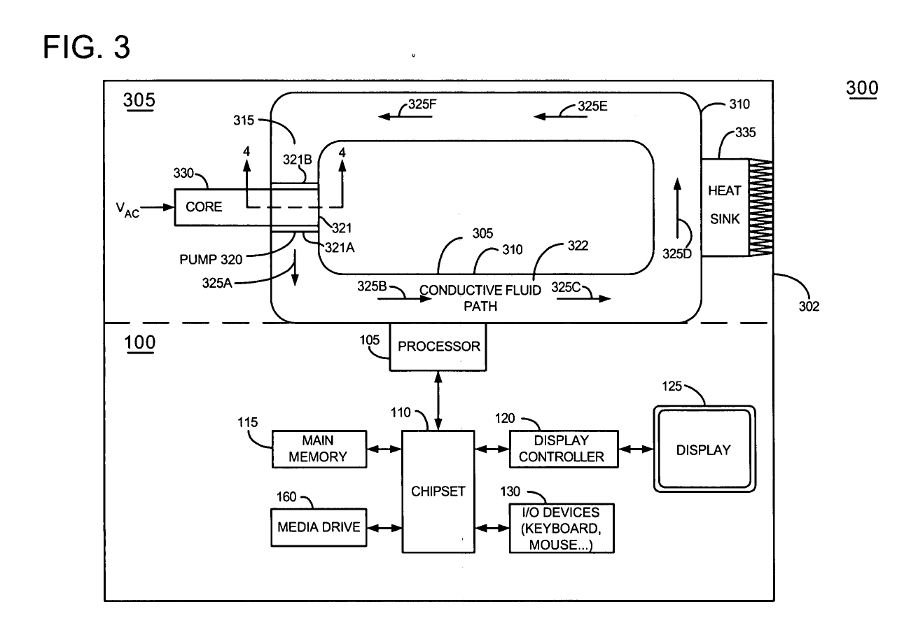

FIG. 3 is an illustration of a system 300 wherein the disclosed cooling apparatus 305 is employed to remove heat from a heat producing device such as processor 105 of information handling system 100. While the disclosed cooling technology is shown in FIG. 3 as being used to remove heat from a processor 105, it can be used as well to cool other heat generating devices such as video graphics controllers, power FETs, power bipolar devices, other semiconductor devices, power supplies and virtually any heat producing device. System 300 includes an enclosure or case 302 in which the system is mounted or otherwise situated.

Cooling apparatus 305 includes a pipe 310 to which a heat producing device, namely processor 105 in this particular example, is thermally coupled. In one embodiment, pipe 310 is formed of a metallic material. Pipe 310 need not be electrically conductive or thermally conductive. However, the liquid within the pipe is electrically and thermally conductive. In the embodiment shown in FIG. 3, processor 105 can be directly mechanically coupled to pipe 310, or alternatively, a layer of thermal grease may be used therebetween to enhance the thermal connection of the processor to the pipe. Pipe 310 is filled with an electrically conductive fluid 315 such as liquid metal, for example. One type of liquid metal that can be employed as electrically conductive fluid 315 is a gallium-indium alloy, for example. Processor 105 generates heat which is transferred into pipe 310 and to the liquid metal fluid flowing therein.

An electromagnetic pump (EM pump) 320 is situated within conductive fluid path 322 as illustrated. Pump housing 321 is the main body or vessel of pump 320. Pump housing 321 includes an output 321A which expels fluid into pipe 310 and an input 321B which receives fluid from pipe 310 as shown in FIG. 3. Pump 320 pushes fluid 315 in the direction indicated by arrow 325A. This causes the liquid metal fluid 315 to circulate in conductive fluid path 322 as indicated by arrows 325B, 325C, 325D, 325E and 325F as shown in FIG. 3.

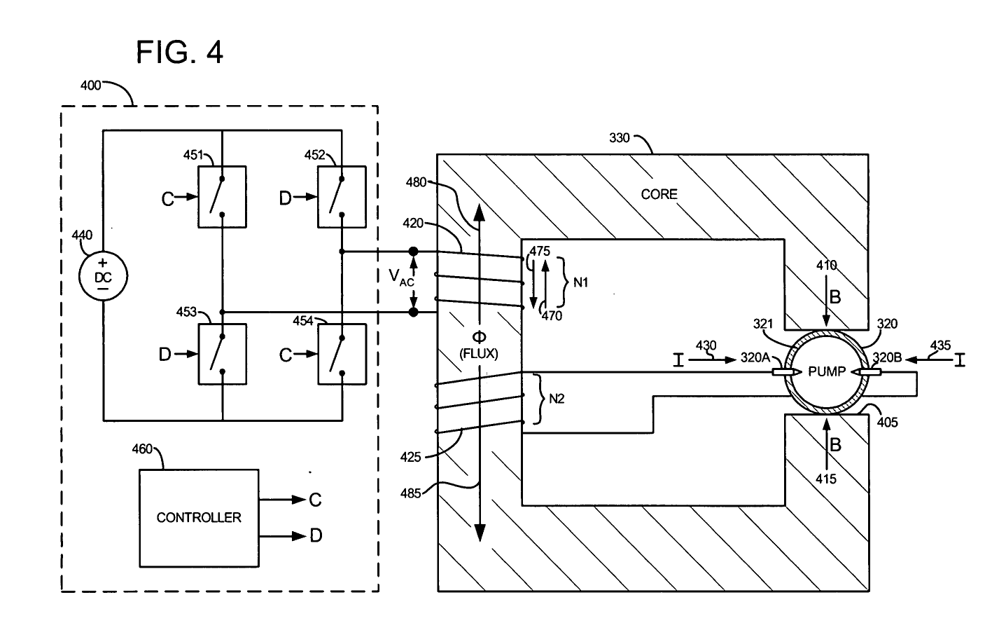

In one embodiment, electromagnetic pump 320 is a Lorentz pump wherein an electric current is applied to the pump such that the current flows through the liquid metal fluid in the pump. The electric current is applied to two electrodes (not shown) which are insulated from pipe 305 and the rest of pump 320. The resultant electric current flows in the fluid between the two electrodes. As will be explained in more detail subsequently, an electromagnet formed by a transformer core 330 generates a magnetic field which is orthogonal to the electric current in the liquid metal fluid. Under these conditions wherein the electric current and magnetic field in the liquid metal are orthogononal to one another, a force is generated in the direction of arrow 325A, that direction being orthogonal to both the electric current and magnetic field discussed above. This force acts on the charges in the electric current in the liquid metal fluid to cause the fluid to move in the direction indicated by arrow 325A. Unlike some conventional Lorentz electromagnetic pumps that operate on direct current (DC) and permanent magnets, pump 320 operates on alternating current (AC) and employs an electromagnet core 330 as will be explained in more detail with reference to FIG. 4.

FIG. 4 is a representation of the disclosed AC driven electromagnetic pump 320 coupled to an AC voltage source 400: AC voltage source 400 generates a voltage V_{AC} at its output which is coupled to the V_{AC} input of transformer core 330. Transformer core 330 is substantially closed to form a complete magnetic loop. EM pump 320 is integrated within core 330 as shown. More particularly, pump 320 is situated within the core in a position which enables the magnetic flux, Φ, passing through the core to pass through pump 320 and the electrically conductive fluid therein. In this particular embodiment, pump 320 is situated within an opening 405 in transformer core 330 such that the magnetic flux or B field passes through the electrically conductive fluid in pump 320 in a first direction indicated by arrow 410 in the positive going portion of an AC cycle and in an opposite second direction 415 in the negative going portion of an AC cycle. When an AC cycle is spoken of here, we mean the AC cycle of the V_{AC} signal provided to primary or transformer input winding 420 and the AC cycle of the resultant voltage that appears by induction on the secondary or transformer output winding 425 of the transformer formed by the core and the primary and secondary windings. The positive going portion of the AC cycle may be alternatively referred to as a positive polarity and the negative going portion of the AC cycle may be referred to as a negative polarity.

Primary winding 420 includes a number of turns, N1, and secondary winding 425 includes a number of turns N2. In this particular embodiment, the transformer is a step down transformer and the number of primary turns, N1, is larger than the number of secondary turns, N2. This causes a low voltage, high current AC signal to be generated in secondary winding 425. Secondary transformer winding 425 is coupled to pump electrodes 320A and 320B such that the low voltage, high current AC signal passes between electrodes 320A and 320B and the electrically conductive fluid therebetween in pump 320. More particularly, during the positive going portion of an AC cycle the electric current, I, passes from electrode 320A through the fluid to electrode 320B in direction 430. However, during the negative going portion of an AC cycle the electric current, I, passes through the fluid in the pump in the opposite direction 435, namely from electrode 320B to electrode 320A as seen in FIG. 4.

As seen in FIG. 4 the direction of the magnetic B field is orthogonal to the direction of the electric current, I, during both the positive and negative portions of the AC signal cycle. This causes a force to be exerted on the electric charges in the current, I, passing through the fluid in pump 320. As viewed in FIG. 4, this force pushes the electrically conductive fluid either into or out of the drawing page of FIG. 4, depending on the convention selected. For example purposes, it is assumed that the force pushes the fluid into the paper. It is important to note that when the electric current, I, changes polarity as the input voltage, V_{AC}, changes polarity from the positive portion to the negative portion of the AC cycle, the B field also changes polarity. Since both the electric current, I, and the B field are changing polarity at substantially the same time, this has the effect of pushing the charges in the electrically conductive fluid in the same direction (here into the paper) during both the positive portion of the AC cycle and the negative portion of the AC cycle.

From the above discussion, it is seen that the disclosed electromagnetic pump 320 is AC driven since voltage source 400 is an AC voltage source. In one embodiment, the AC voltage can be derived from the AC which is present on the AC mains. In another embodiment depicted in FIG. 4, the local voltage source that may be available is a DC source 440. In that case, the AC voltage source 400 can be a DC to AC converter such as the switched mode converter shown in FIG. 4. In this manner, when the local supply is a DC voltage source 440, electromagnetic pump 320 is still AC driven due to the conversion from DC to AC within AC voltage source 400.

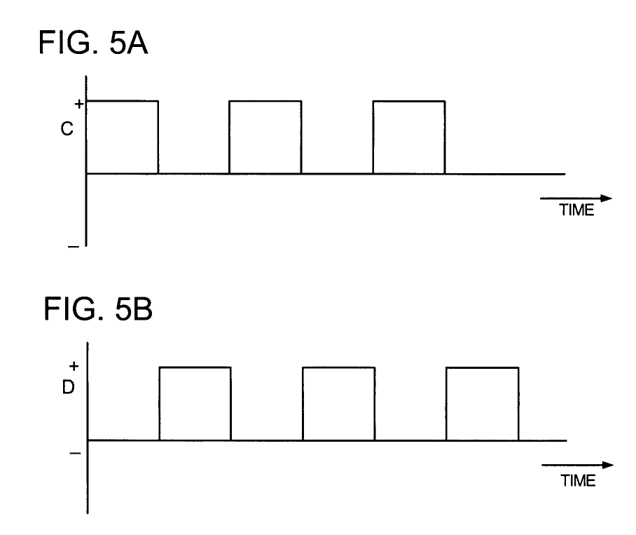

More particularly, to carry out the conversion from the DC voltage of DC voltage source 440 to the AC required to drive electromagnetic pump 320, switching field effect transistors (FETs) 451, 452, 453 and 454 are employed in the configuration shown in FIG. 4. Controller 460 includes a C output that is coupled to the C inputs of both of switching transistors 451 and 454 to control the times that these transistors are switched on and off. The control signal shown in FIG. 5A is the control signal provided to the C inputs of transistors 451 and 454. Controller 460 also includes a D output that is coupled to the D inputs of both of switching transistors 452 and 453 to control the times that these transistors are switched on and off. The control signal shown in FIG. 5B is the control signal provided to the D inputs of transistors 452 and 453. When the C signal switches both transistors 451 and 454 on at substantially the time, transistors 452 and 453 are held off by the D control signal. Conversely, when the switching transistor 452 and 453 are turned on by the D control signal, the C control signal holds transistors 451 and 454 off.

DC is converted to AC in the following manner. When the C control signal turns switch transistors 451 and 454 on, transistors 452 and 453 are off, such that current from DC source 440 flows through switch 451, through primary winding 420 in the direction indicated by arrow 470, through switch 454 and back to DC voltage source 440. Then when the D control signal subsequently turns switching transistors 452 and 453 on, transistors 451 and 454 are off, such that current from DC source 440 now flows through switch 452 through primary winding 420 in the direction indicated by arrow 475 (the opposite of direction 470), through switch 453 and back to DC voltage source 440. Thus, an alternating current is generated in primary winding 420 with the current flowing through winding 420 first in direction 470, then direction 475, then again in direction 470 and so forth. In this manner, an AC voltage is provided to the V_{AC} input of the transformer. While the duty cycles of the control signals of FIG. 5A and 5B are 50%, duty cycles greater than 50% or less than 50% can also be employed depending on the particular application. Moreover, while in one embodiment the current and voltage in the transformer are in phase, other embodiments are possible wherein the current and voltage are out of phase. For example, the current and voltage in the transformer may exhibit a phase shift of 45 degrees, or other phase shifts such as 30, 60 and 70 degrees, for example. Moreover, embodiments are possible wherein the current and voltage may be in or out of phase on either the primary or secondary.

Other power supply circuits can be used as well to provide the V_{AC} signal to the transformer. For example, a variable frequency switching converter can be used as a switched frequency converter. Both resonant and non-resonant switching supply structures can also be employed. A full bridge, phase shifted switching supply structure can be used as well. Whatever the supply selected, it is important that the output of the supply provides an AC voltage to the primary winding 420 of the transformer.

In the embodiment illustrated in FIG. 4, core 330 is made of ferromagnetic material and exhibits a generally square geometry in the cross section shown. Other geometries such as rectangular, circular, and elliptical, for example, can be used as well for core 330. Primary winding 420 and secondary winding 425 are not drawn to scale. By way of example and not limitation, one turns ratio N2/N1 that can be employed is N2/N1=0.03/3=0.01 such that a V_{AC} of 3 volts supplied to primary winding 420 results in a secondary winding voltage of 30 mV and a secondary winding current, I, of 30 Amps. Voltages and currents greater and lesser than these can be employed as desired according to the particular application. Transformer action produces a low voltage, high current AC signal, I, in secondary winding 425. This low voltage, high current AC signal performs two functions, namely, 1) it produces the magnetic flux, Φ, within core 330 that generates the magnetic B field flowing through the liquid metal fluid in the pump, and 2) it supplies the electric current I flowing between electrodes 320A and 320B. It is noted that magnetic flux, Φ, flows in a direction 480 during one half cycle of the AC signal and in the opposite direction 485 during the other half cycle of the AC signal. Thus, both the B field and the electric current, I, reverse polarity substantially simultaneously every half cycle of the AC signal to keep pushing liquid metal fluid through pump 320 with a force in the same direction regardless of the polarity of the particular half cycle of the AC signal.

In embodiments where pump 320 is fabricated from metallic material, electrodes 320A and 320B are electrically insulated from pump housing 321 by insulators (not shown). Other embodiments are contemplated wherein pump 320 is fabricated of non-metallic or electrically insulative material.

It is noted that electromagnetic pump 320 is advantageously integrated in the electromagnet's core 330 such that the same structure produces both the B field and the electric current, I, that push the liquid metal fluid out of the pump. As seen in FIG. 3, the liquid metal fluid is forced out of the pump in a direction 325A where it circulates along the conductive fluid path as indicated by arrows 325A-F. Heat sink 335 is thermally coupled to pipe 310 as shown. More particularly, heat sink 335 is situated along the conductive fluid path 322 within pipe 310. Heat sink 335 is positioned adjacent an external surface of enclosure 325 so that heat transmitted from heat producing device 105 and along conductive fluid path 322 can be exhausted by heat sink 335 to the environment.

A system is thus provided in which heat producing device 105 is cooled by an AC driven electromagnetic pump without the inefficiency associated with secondary rectification. The system can be employed to cool many different types of heat producing devices and is not limited to the particular heat producing device shown.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

What is claimed is:

1. An information handling system (IHS) comprising:
an AC power input operable to be driven by an AC signal;
a vessel including a fluid input and a fluid output and having an electrically conductive fluid contained therein; and
a transformer, coupled to the AC power input, configured to provide the fluid in the vessel with an electric current that is substantially orthogonal to a magnetic field such that a force is generated which pushes the fluid through the fluid output during both positive and negative polarities of the AC signal.

2. The IHS of claim 1 wherein both the magnetic field and the electric current reverse direction each time the polarity of the AC signal changes.

3. The IHS system of claim 1 further comprising a pipe coupled to the fluid input and the fluid output to create a closed loop fluid path.

4. The IHS of claim 3 further comprising a heat producing device thermally coupled to the pipe at a first location of the pipe.

5. The IHS of claim 4 further comprising a heat sink coupled to the pipe at a second location of the pipe to exhaust heat.

6. The IHS of claim 4 wherein the heat producing device as a processor.

7. The IHS of claim 1 wherein the transformer is a step-down transformer.

8. The IHS of claim 1 including a DC to AC converter coupled to the AC power input.

9. The IHS of claim 1 wherein the electrically conductive fluid is liquid metal.

10. The IHS of claim 1 wherein the transformer includes a ferromagnetic core about which a primary and secondary winding are situated, the primary winding being coupled to the AC power input, the pump being integrated into the ferromagnetic core such that the core exerts a magnetic field on the fluid and the secondary winding provides an AC electric current which is orthogonal to the magnetic field, thus generating a force pushing the fluid out the fluid output on both positive and negative polarities of the AC electric current.

11. A method of operating an information handling system comprising:
providing an electrically conductive fluid to an electromagnetic (EM) pump having a fluid input and a fluid output;
supplying AC electric current to a transformer to generate a magnetic field in which the EM pump is positioned; and
supplying AC electric current to the fluid within the EM pump, the EM pump being configured such that the AC electric current in the fluid within the EM pump is substantially orthogonal to the magnetic field in the fluid within the EM pump, thus imparting a force on the fluid to push the fluid through the fluid output during both positive and negative polarities of the AC electric current supplied to the EM pump.

12. The method of claim 11 further comprising integrating the EM pump in a ferromagnetic core of the transformer.

13. The method of claim 11 further comprising coupling a pipe to the input and output of the EM pump to create a closed loop fluid path along which the fluid flows.

14. The method of claim 13 further comprising thermally coupling a heat producing device to the pipe to conduct heat away from the heat producing device.

15. The method of claim 14 wherein the heat producing device is a semiconductor device.

16. The method of claim 14 wherein the heat producing device is a processor.

17. The method of claim 14 further comprising removing heat from the pipe by thermally coupling the pipe to a heat sink.

18. The method of claim 11 wherein the AC electric current that is supplied to the pump is generated by a secondary of the transformer which includes a primary to which an AC current is supplied to generate the magnetic field.

19. The method of claim 11 further comprising supplying the AC electric current to the transformer by using a DC to AC converter.

20. The method of claim 11 wherein the electrically conductive fluid is liquid metal.

21. A cooling system comprising:
an AC power input operable to be driven by an AC signal;
an electromagnetic pump including a fluid input and a fluid output and having an electrically conductive fluid contained therein; and
a transformer, coupled to the AC power input, configured to provide the fluid in the electromagnetic pump with an electric current that is substantially orthogonal to a magnetic field such that a force is generated which pushes the fluid through the fluid output during both positive and negative polarities of the AC signal.

22. The cooling system of claim 21 wherein both the magnetic field and the electric current reverse direction each time the polarity of the AC signal changes.

23. The cooling system of claim 21 wherein the transformer is a step-down transformer.

24. The cooling system of claim 21 including a DC to AC converter coupled to the AC power input.

25. The cooling system of claim 21 including a pipe coupled to the fluid input and the fluid output to create a closed loop fluid path.

26. The cooling system of claim 25 including a heat producing device thermally coupled to the pipe at a first location of the pipe.

27. The cooling system of claim 26 including a heat sink thermally coupled to the pipe at a second location of the pipe to exhaust heat from the pipe.

28. The cooling system of claim 26 wherein the heat producing device is a processor.

29. The cooling system of claim 28 wherein the processor is part of an information handling system.

30. The cooling system of claim 21 wherein the electrically conductive fluid is liquid metal.

31. A pumping system comprising:
an AC power input operable to be driven by an AC signal;
an electromagnetic pump including a fluid input and a fluid output and having an electrically conductive fluid contained therein; and
a transformer including a ferromagnetic core about which a primary and secondary winding are situated, the primary winding being coupled to the AC power input, the pump being integrated into the ferromagnetic core such that the core exerts a magnetic field on the fluid, the secondary winding providing an AC electric current which is substantially orthogonal to the magnetic field in the fluid, thus generating a force pushing the fluid out the fluid output on both positive and negative polarities of the AC electric current.

32. The pumping system of claim 31 wherein both the magnetic field and the AC electric current reverse direction each time the polarity of the AC signal changes.

33. The pumping system of claim 31 wherein the transformer is a step-down transformer.

34. The pumping system of claim 31 including a DC to AC converter coupled to the AC power input.

35. The pumping system of claim 31 including a pipe coupled to the fluid input and the fluid output to create a closed loop fluid path.

36. The pumping system of claim 35 including a heat producing device thermally coupled to the pipe at a first location of the pipe.

37. The pumping system of claim 36 including a heat sink thermally coupled to the pipe at a second location of the pipe to exhaust heat from the pipe.

38. The pumping system of claim 36 wherein the heat producing device is a processor.

39. The pumping system of claim 38 wherein the processor is part of an information handling system.

40. The pumping system of claim 31 wherein the electrically conductive fluid is liquid metal.

41. A method of operating a cooling system comprising:
supplying AC electric current to a transformer that generates a magnetic field through an EM pump containing an electrically conductive fluid, and
supplying, by the transformer, AC electric current to the fluid in the pump to generate an electric field in the fluid which is substantially orthogonal to the magnetic field to create a force pushing the fluid through the pump in the same direction for both positive and negative polarities of the AC electric current.

42. The method of claim 41 wherein both the magnetic field and the electric current reverse direction each time the AC electric current changes polarity.

43. The method of claim 41 wherein the EM pump is integrated into a ferromagnetic core of the transformer.

44. The method of claim 41 including a pipe coupled to the fluid input and the fluid output to create a closed loop fluid path.

45. The method of claim 41 including coupling a pipe to the fluid input and the fluid output to create a closed loop fluid path.

46. The method of claim 45 including thermally coupling a heat producing device to the pipe at a first location of the pipe.

47. The method of claim 46 including thermally coupling a heat sink to the pipe at a second location of the pipe to exhaust heat from the pipe.

48. The method of claim 46 wherein the heat producing device is a processor.

49. The method of claim 41 wherein the transformer includes a primary and a secondary, primary AC current being supplied to the primary to generate the magnetic field and to induce secondary AC current in the secondary, the secondary AC electric current being supplied to the fluid in the pump such that the secondary AC electric current is orthogonal to the magnetic field.

50. A method of operating an electromagnetic pump comprising:
supplying a first polarity of an AC signal to an electrically conductive fluid in the pump to generate an electric current which is substantially orthogonal to a magnetic field within the fluid; and
supplying a second polarity of the AC signal to the fluid to reverse directions of both the electric current and the magnetic field, thus pushing the fluid in the same direction for the first and second polarities of the AC signal.
